(19) United States
(12) Patent Application Publication
(10) Pub. No.: US 2022/0180314 A1
(43) Pub. Date: Jun. 9, 2022

(54) A SYSTEM AND METHOD FOR AUTOMATED TRACKING OF ITEM/S

(71) Applicant: CARRIER CORPORATION, Palm Beach Gardens, FL (US)

(72) Inventors: Sunil Kimar Balis, Hyderabad, Telangana (IN); Luca Bertuccelli, West Hartford, CT (US); Peter Borenstein, Jacksonville, FL (US); Ramakrishna Gattu, Hyderabad, Telangana (IN)

(21) Appl. No.: 17/252,370

(22) PCT Filed: Jul. 22, 2020
(86) PCT No.: PCT/IB2020/056865

§ 371 Date: Dec. 15, 2020

(30) Foreign Application Priority Data
Aug. 8, 2019 (IN) 201911032244

(51) Int. Cl. G06Q 10/08; G06Q 30/06

(52) U.S. Cl. CPC G06Q 10/0875; G06Q 30/0639

(57) ABSTRACT

Aspects of the invention are directed towards a system and a method automated tracking of item/s. One or more embodiments of the invention describe a method comprising steps of detecting location of an item by a first communication module or a second communication module, the item coupled to an electronic circuit and receiving data corresponding to one or more parameters associated with the item. The method further comprises step of transmitting the location along with the data corresponding to the parameters associated with the item to a server by the first communication module when the item is placed inside a receptacle or by the second communication module when the item is placed outside the receptacle.

### TECHNICAL FIELD OF INVENTION

The present invention relates generally to tracking of item/s. More particularly, the invention relates to a system and a method for automated tracking of item/s.

### BACKGROUND OF THE INVENTION

One or more items having content having short shelf lives such as medicines, food items and the like are manufactured by a manufacturer, packed and then transported in a receptacle or a container to a retail store. When the one or more items reach the retail store, end user or consumer purchases the one or more items and consumes/use the content in the one or more item. From the place of manufacturer to the place of end consumer, the one or more items are made to travel in a receptacle or a box from one location to another location. The manufacturer of the one or more items may want to know location information of the one or more items present in the receptacle while the one or more items in the receptacle are in transit. The manufacturer of the one or more items may also be interested and may want to know the location information of a place where the one or more items are finally consumed/used by the end user. The tracking of the location of the items is important for integrity of the items.

The existing solution to track the location information of the one or more items uses sensors to track the location information of the one or more items. However, such existing solution requires manual intervention for knowing the location information of the one or more items. Further, the manufacturer of the one or more items is currently unable to automatically track the location information of the one or more items present in the receptacle during transit and the location information of the place where the one or more items are finally consumed/used by the end user.

In view of the afore-mentioned problems, there is a need of an effective system and a method for automatically track the one or more items present in the receptacle during in transit. There is also a requirement of an effective system and a method for automatically track the location information of the place where the one or more items are finally consumed/used by the end user. There is also a need of a system and a method for automatically track the one or more items without any manual intervention. In order to solve the problems in the existing art, a system and a method is disclosed for automated tracking of item/s that addresses the afore-mentioned problems.

### SUMMARY OF THE INVENTION

Various embodiments of the invention describe a method and a system for automated tracking of item/s. The invention discloses a system comprising an item coupled to an electronic circuit and a first communication module in communication with the electronic circuit to receive data corresponding to one or more parameters associated with the item, wherein the item, the electronic circuit and the first communication module are located in a receptacle. Further, a server in communication with the first communication module when the item is placed inside the receptacle and with a second communication module when the item is placed outside the receptacle. Further, the server is configured to receive data and location of the item from the first communication module or the second commination module.

In an embodiment of the invention, the location of the item is determined by the first communication module and the second communication module and provided to the server.

In another embodiment of the invention, the location of the item is transmitted to the server when the item is opened by a user.

In a further embodiment of the invention, the first communication module and the second communication module determine the location of the item by calibrating received signal strength from the item and adding the location of the first communication module and the second communication module to the data before sending to the server, wherein the received signal strength is determined based on the communication between the item and the first communication module or between the item and the second communication module.

In yet another embodiment of the invention, the electronic circuit and the first communication module of the receptacle communicates through a short-range communication channel, wherein the first communication module of the receptacle and the server communicates through a cellular communication channel.

In a different embodiment of the invention, the electronic circuit includes a short-range transceiver for communicating with the first communication module or the second communication module.

In another embodiment of the invention, the second communication module transmits the data and the location to the server through a cellular communication channel.

In a further embodiment of the invention, the server is provisioned with a map associated with a premises, wherein the first communication module or the second communication module may transmit location information to the server, wherein the location information include location of the first communication module or the second communication module and the received signal strength received by the first communication module and the second communication module from the item, wherein the server determines the location of the item based on the location information. Also, the location of the item determined by the server is provided to the map.

In yet another embodiment of the invention, the second communication module, the first communication module, the one or more items are associated with unique identifiers.

In a different embodiment of the invention, the one or more parameters include a temperature parameter, a motion parameter, or a humidity parameter associated with the item, wherein the each of the parameters are sensed by a temperature sensor, an accelerometer and a humidity sensor, respectively.

In yet another embodiment of the invention, a method is disclosed for automated tracking of item/s comprising the steps of detecting location of an item by a first communication module or a second communication module, the item is coupled to an electronic circuit and receiving data corresponding to one or more parameters associated with the item by the first communication module or the second communication module. The method further comprising step of transmitting the location along with the data corresponding to the parameters associated with the item to a server by the first communication module when the item is placed inside a receptacle or by the second communication module when the item is placed outside the receptacle.

In an embodiment of the invention, the location of the item is determined by the first communication module and the second communication module and provided to the server.

In another embodiment of the invention, the location of the item is transmitted to the server when the item is opened by a user.

In a further embodiment of the invention, the first communication module and the second communication module determine the location of the item by calibrating received signal strength from the item and adding the location of the first communication module and the second communication module to the data before sending to the server, wherein the received signal strength is determined based on the communication between the item and the first communication module or between the item and the second communication module.

In yet another embodiment of the invention, the electronic circuit and the first communication module of the receptacle communicate through a short-range communication channel, wherein the first communication module of the receptacle and the server communicate through a cellular communication channel.

In a different embodiment of the invention, the electronic circuit includes a short-range transceiver for communicating with the first communication module or the second communication module.

In another embodiment of the invention, the second communication module transmits the data and the location to the server through a cellular communication channel.

In a further embodiment of the invention, the server is provisioned with a map associated with a premises, wherein the first communication module or the second communication module may transmit location information to the server, wherein the location information includes location of the first communication module or the second communication module and the received signal strength received by the first communication module and the second communication module from the item, wherein the server determines the location of the item based on the location information.

In various other embodiments of the invention, a computer readable medium is disclosed comprising one or more processors and a memory coupled to the one or more processors. The memory stores instructions which are executed by the one or more processors to detect, by a first communication module or a second communication module, location of an item, the item coupled to an electronic circuit and receive data corresponding to one or more parameters associated with the item by the first communication module or the second communication module. The memory also stores instructions which are executed by the one or more processors to transmit the location along with the data corresponding to the one or more parameters associated with the item to a server by the first communication module when the item is placed inside a receptacle or by the second communication module when the item is placed outside the receptacle.

This summary is provided to introduce a selection of concepts in a simplified form from those are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 depicts an exemplary architecture for automated tracking of item/s, according to a first embodiment of the invention.

FIG. 2 depicts an exemplary architecture for automated tracking of item/s, according to a second embodiment of the invention.

FIG. 3 depicts block diagram of different components in an electronic circuit coupled to an item according to an exemplary embodiment of the invention.

FIG. 4 depicts block diagram of different components in a first communication module/a second communication module according to an exemplary embodiment of the invention.

FIG. 5 depicts an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology for a system and a method for automated tracking of item/s. Further, the item is coupled to an electronic circuit. The electronic circuit of the item communicates with a first communication module of a receptacle/container through a short-range communication channel when the item is placed inside the receptacle. Also, the electronic circuit of the item communicates with a second communication module through a short-range communication channel when the item is placed outside the receptacle, for example, when the item is placed in a premises such as a dispensary or room inside a hospital and the like. Also, the first communication module of the receptacle communicates with a server through a cellular communication channel when the item is placed inside the receptacle and the second communication module communicates with the server through a cellular communication channel when the item is placed outside the receptacle and is placed in the premises. The first communication module and the second communication module transmit data corresponding to the parameter/s associated with the item/s as well location of the item to the server.

As used herein, the item includes content for consumption or usage by an end customer. Such item may be a bottle or a box having liquid content, solid content or semi solid content or any such item known in the art. The content in the item may be for any kind of consumption/usage and may be a pharmaceutical content, a liquid content, an eatable content, a lotion, a cream, tablets or any such content known in the art.

As used herein, the server has some processing capabilities and may also communicate with the first communication module and/or the second communication module through a cellular communication channel. The server may be a cloud storage, a remote database, or any such storage known in the art.

As used herein, the short-range communication channel may refer to a communication channel established through a WiFi access point, a bluetooth network, a near-field network, or a ZigBee network.

As used herein, the cellular communication channel may refer to a communication channel established through a Global System for Mobile (GSM) network, Long-Term Evolution (LTE) network, a code-division multiple access (CDMA) network, a narrow-band internet of thing (NB-IoT) technique or category M1 technique or any such network/technique that is known in the art.

As used herein, the electronic circuit is coupled to the item and may include a short-range transceiver, a cellular transceiver, and one or more sensors to sense parameter/s, accelerometer, battery, a limit switch, a processor and/or a memory.

As used herein, the one or more sensors may possess capability of sensing/monitoring one or more environmental parameters associated with the item. The one or more sensors can sense the temperature, humidity, smoke, gas, fire, or air pressure of the external environment where the item is placed or present. The one or more sensors may include, but not limited to, a temperature sensor, a humidity sensor, a smoke sensor, a gas sensor, a fire sensor, an air pressure sensors or any such sensor that is obvious to a person skilled in the art.

As used herein, the parameter/s that are to be sensed by one or more sensors may include, but not limited to, temperature parameter, humidity parameter, air pressure parameter, smoke parameter, gas parameter, fire parameter or any such parameter that is known in the art.

As used herein, the first communication module and or the second communication module may be a module with a capability of short-range communication with the electronic circuit of the item as well as cellular communication with the server. Also, the first communication module and or the second communication module may have a short-range transceiver, a cellular transceiver, a location detector unit, a processor and/or a memory.

Throughout the specification, reference numeral 106 can be considered as one or more items. The reference numeral 106A, 106B, 106C . . . 106N can be considered as single item. Likewise, reference numeral 110 can be considered as one or more electronic circuit. The reference numeral 110A, 110B, 110C . . . 110N can be considered as single electronic circuit.

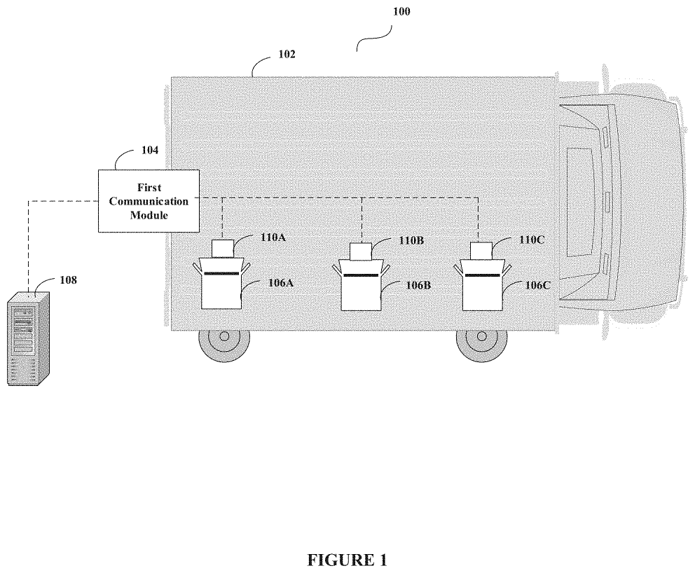

FIG. 1 depicts an exemplary architecture 100 for automated tracking of item/s, according to an exemplary first embodiment of the invention. The exemplary architecture 100 comprises a receptacle 102, a first communication module 104 associated with the receptacle 102, an item 106 coupled to an electronic circuit 110 placed inside the receptacle 102 and a server 108 connected with the first communication module 104. As used herein, the receptacle 102 may be part of a transportation storage unit. Further, the item 106, the electronic circuit 110 and the first communication module 104 are located in the receptacle 102.

As depicted in FIG. 1, the item 106 is placed inside the receptacle 102 and the electronic circuit 110 coupled to the item 106. The receptacle 102 is in transit and may move from one location to another. In this exemplary first embodiment, the electronic circuit 110 of the item 106 may communicate with the first communication module 104 associated with the receptacle 102 while the receptacle is in transit. Such communication between the first communication module 104 and the electronic circuit 110 may be through a short-range communication channel. Further, as can be seen, the first communication module 104 may in turn communicate with the server 108 through a cellular communication channel. Although the FIG. 1 depicts only one first communication module 104 associated with the receptacle 102, however, it is understood for a person skilled in the art that the receptacle 102 can have more than one first communication module 104.

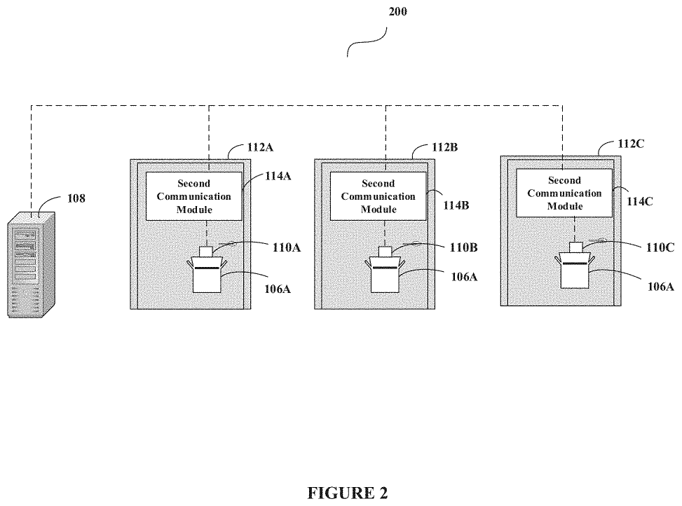

FIG. 2 depicts an exemplary architecture 200 for automated tracking of item/s, according to an exemplary second embodiment of the invention. The exemplary architecture 200 comprises a premises 112, a second communication module 114 associated with the premises 112, an item 106 coupled to an electronic circuit 110 placed inside the premises 112 and a server 108 connected with the second communication module 112. As can be seen in FIG. 2, the item 106 is placed in the premises 112 which is stationary and not placed inside the receptacle 102 i.e. as per the exemplary second embodiment of the present invention, the item 106 is placed outside the receptacle 102. As used herein, the premises 112 may be a room in a building (for e.g. a hospital, an office or a shopping mall) and the second communication module 114 may be deployed in each room of the building. In this exemplary second embodiment, the electronic circuit 110 of the item 106 may communicate with the second communication module 114 associated with the premises 112. Such communication between the second communication module 114 and the electronic circuit 110 may be through a short-range communication channel. Further, as can be seen, the second communication module 114 may in turn communicate with the server 108 through a cellular communication channel. Although the FIG. 2 depicts only one second communication module 114 associated with the premises 112, however, it is understood for a person skilled in the art that the premises 112 can have more than one second communication module 114.

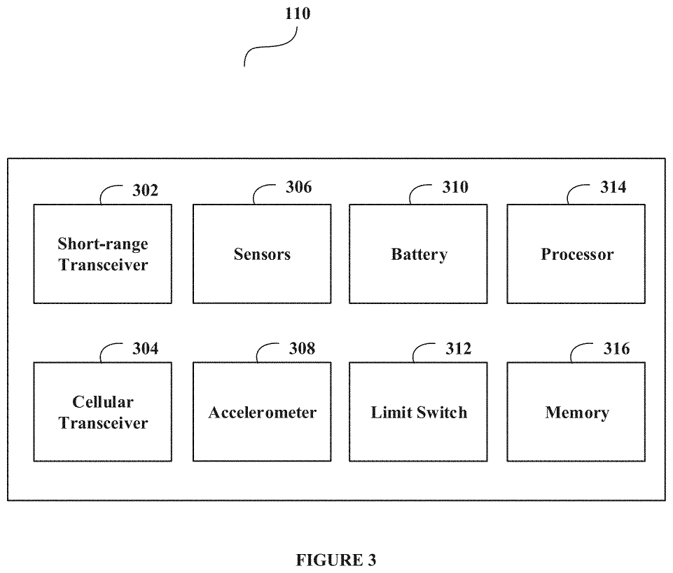

FIG. 3 depicts block diagram of different components in an electronic circuit 110 coupled to an item 106 according to an exemplary embodiment of the invention. The electronic circuit 110 may include a short-range transceiver 302, a cellular transceiver 304, one or more sensors 306, an accelerometer 308, a battery 310, a limit switch 312, a processor 314 and/or a memory 316. The one or more sensors 306 of the electronic circuit 110 may sense parameter/s inside the receptacle 102 or the premises 112 wherever the item 106 is placed. Further, the limit switch 312 of the electronic circuit 110 may detect an opening status associated with the item 106 whether the item 106 has been opened by a user or not. Also, the accelerometer 308 of the electronic circuit 110 may detect a motion status of the item 106 if the item 106 is in transit based on motion of the receptacle 102. The electronic circuit 110 may periodically or on occurrence of an event sense the parameter/s inside the receptacle 102 or the premises 112, detect the opening status and detect the motion status of the item 106.

Then, the short-range transceiver 302 of the electronic circuit 110 may transmit data corresponding to the sensed parameter/s, the opening status of the item 106 and/or the motion status of the item 106 to the first communication module 104 if the item 106 is placed inside the receptacle 102. Alternatively, the short-range transceiver 302 of the electronic circuit 110 may transmit data corresponding to the sensed parameter/s, the opening status of the item 106 and/or the motion status of the item 106 to the second communication module 114 if the item 106 is placed outside the receptacle 102 and in the premises 112. The short-range transceiver 302 of the electronic circuit 110 may communicate with the first communication module 104 or with the second communication module 114 over a short-range communication channel. Also, the short-range transceiver 302, the cellular transceiver 304, the one or more sensors 306, the accelerometer 308, the battery 310, the limit switch 312 and/or the memory 316 may be communicably coupled with the processor 314.

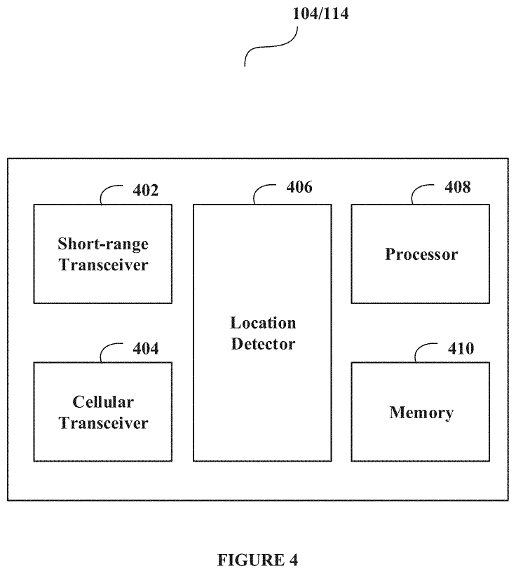

FIG. 4 depicts block diagram of different components in a first communication module 104 or a second communication module 114 according to an exemplary embodiment of the invention. The first communication module 104 or the second communication module 114 may include a short-range transceiver 402, a cellular transceiver 404, a location detector 406, a processor 408 and/or a memory 410. The short-range transceiver 402 of the first communication module 104 or the second communication module 114 may receive the data corresponding to the sensed parameter/s, the opening status of the item 106 and/or the motion status of the item 106 over the short-range communication channel. The location detector 406 of the first communication module 104 or the second communication module 114 may determine location of the item 106 associated with the receptacle 102 (in FIG. 1) or the premises 112 (in FIG. 2) wherever the item 106 is placed. In an exemplary embodiment, the location of the item 106 associated with the receptacle 102 or the premises 112 is detected by a global positioning system (GPS) of the first communication module 104 or the second communication module 114. The cellular transceiver 404 of the first communication module 104 or the second communication module 114 may then transmit the location of the item 106 associated with the receptacle 102 or the premises, the data corresponding to the sensed parameter/s, the opening status of the item 106 and/or the motion status of the item 106 to the server 108 over a cellular communication channel. When the server 108 receives the data corresponding to the sensed parameter/s, the opening status of the item 106, the motion status of the item 106 and/or the location of the item 106 from the first communication module 104 or the second communication module 114, a manufacturer of the item 106 may access the server 108 through the network and may track the item 106 by using the location of the item 106 associated with the receptacle 102 or the premises 112. In specific, a customer or the manufacturer of the item 106 may access the server 108 by using a web application or a mobile application to view/see the location of the item 106 associated with the receptacle 102 or the premises 112. Also, the short-range transceiver 402, the cellular transceiver 404, the location detector 406 and/or the memory 410 may be communicably coupled with the processor 408.

The present invention encompasses the electronic circuit 110 of the item 106 which periodically or on occurrence of an event may transmit the data corresponding to the sensed parameter/s, the opening status of the item 106, and/or the motion status of the item 106 to the first communication module 104 or the second communication module 114 over the short-range communication channel. However, it is well understood for a person skilled in the art that the electronic circuit 110 of the item 106 may transmit the data corresponding to the sensed parameter/s, the opening status of the item 106, and/or the motion status of the item 106 to the first communication module 104 or the second communication module 114 over the cellular communication channel.

As discussed above, whenever the item 106 is placed inside the receptacle 102, the electronic circuit 110 of the item 106 communicates with the first communication module 104 associated with the receptacle 102. And, when the item 106 is placed outside the receptacle 102 and in the premises 112, the electronic circuit 110 of the item 106 communicates with the second communication module 114 associated with the premises 112. The first communication module 104 and/or the second communication module 114 may then in turn communicate with the server 108.

The present invention encompasses the first communication module 104 and/or the second communication module 114 to determine the location of the item 106 using the location detector 406. For this, the location detector 406 of the first communication module 104 and/or the second communication module 114 may first detect a presence of the item 106 placed inside the receptacle 102 or the premise 112. The first communication module 104 and/or second communication module 114 may determine the presence of the item 106 when the item 106 starts advertising for a connection request. For an instance in FIG. 2, the second communication module 114A of the premises 112A may determine a presence of item 106A which is placed in the premises 112A.

Then, the first communication module 104 of the receptacle 102 and/or and the second communication module 114 of the premise 112 may detect the advertisement from the item 106. When the item 106 transmits the data and the status to the first communication module 104 and/or the second communication module 114, the item 106 also transmits a unique identifier associated with the item 106. The first communication module 104 and/or the second communication module 114 may determine location of the item 106 using the location of the first communication module 104 or the second communication module 114. The first communication module 104 of the receptacle 104 and/or the second communication module 114 of the premises 112 then may transmit the unique identifier of the item 106 and the location of the item 106 to the server 108. Alternatively, the first communication module 104 of the receptacle 104 and/or the second communication module 114 of the premises 112 determine the location of the item 106 by calibrating received signal strength from the item 106 and adding the location of the first communication module 104 and the second communication module 114 to the data before sending to the server, wherein the received signal strength is determined based on the communication between the item 106 and the first communication module 104 or between the item 106 and the second communication module 114. Further, the unique identifier may also be associated with the first communication module 104 and/or the second communication module 114. In an exemplary embodiment of the invention, the location of the item 106 is transmitted to the server 108 when the item 106 is opened by a user.

The present invention also encompasses the server 108 to be provisioned with a map associated with the premises 112 when the second communication module 114 are deployed at the premises 112. The map associated with the premises 112 may be provisioned to the server 106 at the time of deployment of the second communication module 114 in the premises 112. In an alternative exemplary embodiment, the present invention encompasses the server 108 to determine location of the item 106 by using location information sent by the first communication module 104 and/or the second communication module 114. The server 108 may determine the location of the item 106 by using the location information of the first communication module 104 or the second communication module 114 along with the received signal strength from the electronic circuit 110 coupled with the item 106. The received signal strength may be a signal strength value of a short-range network and or a cellular network associated with the item 106. The first communication module 104 or the second communication module 114 may receive a unique identifier which uniquely identifies the respective item 106. Then, the server 108 may use the map of the premises 112, the received signal strength and the location information sent by the first communication module 104 or the second communication module 114 to determine location of the item 106. Also, the location of the item 106 determined by the server 108 is provided to the map.

The present invention further facilitates the item 106 to store the data corresponding to the sensed parameter/s, the opening status of the item 106, and/or the motion status of the item 106 in the memory 316 or at on-chip flash memory of the item 106 in an event the item 106 is unable to connect with the first communication module 104 or the first communication module 114.

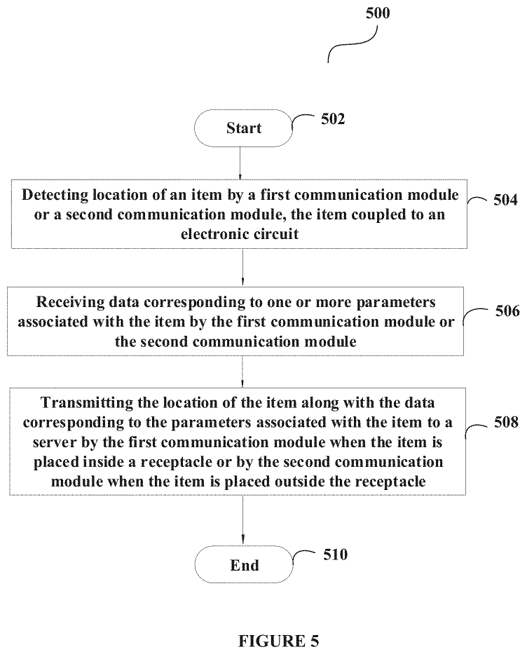

FIG. 5 depicts an exemplary flowchart illustrating a method to perform the invention according to an exemplary embodiment of the invention. The method flowchart 500 describes a method being performed for enabling the invention. The method flowchart 500 starts at step 502.

At step 504, the first communication module 104 or the second communication module 114 may detect location of the item 106 associated with the receptacle 102 or the premises 112, respectively, where the item 106 is placed.

At step 506, the first communication module 104 or the second communication module 114 may receive data corresponding to sensed parameter/s associated with the item 106, an opening status of the item 106 and/or a motion status of the item 106 from the electronic circuit 110 of the item, as discussed above.

At step 508, the first communication module 104 associated with the receptacle 102 may add the location with the data corresponding to the parameter/s corresponding to the parameters associated with the item 106 and then may transmit to a server 108 when the item 106 is placed inside the receptacle 102. Alternatively, the second communication module 114 may add the location with the data corresponding to the parameter/s associated with the item 106 then may transmit to the server 108 when the item 106 is placed in the premises 112 and outside the receptacle 102. The method 500 may end at step 510.

The present invention is applicable in various fields such as, but not limited to, pharmaceutical industry, cosmetics industry, food industry and any such industry that is well known in the art.

The present invention provides the following technical advantages over the existing solutions in the market: a) automated tracking of item eliminates manual intervention, b) provides a low cost solution for automated tracking of the item, c) maintains compact size of the item as there is no requirement to make any changes in the item, and d) automated tracking of item by using the first communication module of the receptacle or the second communication module of the premises.

The embodiments of the invention discussed herein are exemplary and various modification and alterations to a known person skilled in the art are within the scope of the invention.

In one embodiment of the invention, the invention can be operated using the one or more computer readable devices comprising a computer readable medium. The computer readable medium of the computer readable devices is configured to detect, by a first communication module 104 or a second communication module 114, location of an item 106, the item coupled to an electronic circuit and receive data corresponding to one or more parameters associated with the item by a first communication module or the second communication module. The computer readable medium of the computer readable devices is further configured to transmit the location along with the data corresponding to the one or more parameters associated with the item 106 to a server 108 by the first communication module 104 when the item 106 is placed inside a receptacle 102 or by the second communication module 114 when the item 106 is placed outside the receptacle 102.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

We claim:

1. A system comprising:
an item coupled to an electronic circuit; and
a first communication module in communication with the electronic circuit to receive data corresponding to one or more parameters associated with the item, wherein the item, the electronic circuit and the first communication module are located in a receptacle; and
a server in communication with the first communication module when the item is placed inside the receptacle and with a second communication module when the item is placed outside the receptacle, the server further configured to receive data and location associated with the item from the first communication module or the second commination module.

2. The system of claim 1, wherein the location of the item is determined by the first communication module and the second communication module and provided to the server.

3. The system of claim 1, wherein the location of the item is transmitted to the server when the item is opened by a user, wherein the location of the item is received by the manufacturer of the item from the server.

4. The system of claim 1, wherein the first communication module and the second communication module determine the location of the item by calibrating received signal strength from the item and adding the location of the first communication module and the second communication module to the data before sending to the server, wherein the received signal strength is determined based on the communication between the item and the first communication module or between the item and the second communication module.

5. The system of claim 1, wherein the electronic circuit and the first communication module of the receptacle communicates through a short-range communication channel, wherein the first communication module of the receptacle and the server communicates through a cellular communication channel.

6. The system of claim 1, wherein the electronic circuit includes a short-range transceiver for communicating with the first communication module or the second communication module.

7. The system of claim 1, wherein the second communication module transmits the data and the location of the item to the server through a cellular communication channel.

8. The system of claim 1, wherein the server is provisioned with a map associated with a premises, wherein the first communication module or the second communication module may transmit location information to the server, wherein the location information include location of the first communication module or the second communication module and the received signal strength received by the first communication module and the second communication module from the item, wherein the server determines the location of the item based on the location information.

9. The system of claim 8, wherein the location of the item determined by the server is provided to the map.

10. The system of claim 1, wherein the second communication module, the first communication module, the one or more items are associated with unique identifiers.

11. The system of claim 1, wherein the one or more parameters include a temperature parameter, a motion parameter, or a humidity parameter associated with the item, wherein the each of the parameters are sensed by a temperature sensor, an accelerometer or a humidity sensor, respectively.

12. A method comprising:
detecting location of an item by a first communication module or a second communication module, the item coupled to an electronic circuit;
receiving data corresponding to one or more parameters associated with the item by the first communication module or the second communication module; and
transmitting the location of the item along with the data corresponding to the parameters associated with the item to a server by the first communication module when the item is placed inside a receptacle or by the second communication module when the item is placed outside the receptacle.

13. The method of claim 12, wherein the location of the item is determined by the first communication module and the second communication module and provided to the server.

14. The method of claim 12, wherein the location of the item is transmitted to the server when the item is opened by a user.

15. The method of claim 12, wherein the first communication module and the second communication module determine the location of the item by calibrating received signal strength from the item and adding the location of the first communication module and the second communication module before sending to the server, wherein the received signal strength is determined based on the communication between the item and the first communication module or between the item and the second communication module.

16. The method of claim 12, wherein the electronic circuit and the first communication module of the receptacle communicate through a short-range communication channel, wherein the first communication module of the receptacle and the server communicate through a cellular communication channel.

17. The method of claim 12, wherein the electronic circuit includes a short-range transceiver for communicating with the first communication module or the second communication module.

18. The method of claim 12, wherein the second communication module transmits the data and the location of the item to the server through a cellular communication channel.

19. The method of claim 12, wherein the server is provisioned with a map associated with a premises, wherein the first communication module or the second communication module may transmit location information to the server, wherein the location information include location of the first communication module or the second communication module and the received signal strength received by the first communication module and the second communication module from the item, wherein the server determines the location of the item based on the location information.

20. A computer readable medium comprising one or more processors and a memory coupled to the one or more processors, the memory storing instructions which are executed by the one or more processors, the one or more processors configured to:
detect, by a first communication module or a second communication module, location of an item, the item coupled to an electronic circuit;
receive data corresponding to one or more parameters associated with the item by a first communication module or the second communication module; and
transmit the location along with the data corresponding to the one or more parameters associated with the item to a server by the first communication module when the item is placed inside a receptacle or by the second communication module when the item is placed outside the receptacle.
